(19) United States
(12) Patent Application Publication
(10) Pub. No.: US 2017/0374026 A1
(43) Pub. Date: Dec. 28, 2017

(54) ELECTRONIC CONTROL DEVICE

(71) Applicant: Continental Teves AG & Co., oHG, Frankfurt (DE)

(72) Inventors: Torsten Martin, Steinbach/Taunus (DE); Hans Gregor Molter, Darmstadt (DE); Nils Bauch, Idstein (DE); Sven Kretschmar, Gustavsburg (DE)

(73) Assignee: Continental Teves AG & Co., oHG, Frankfurt (DE)

(21) Appl. No.: 15/524,345

(22) PCT Filed: Dec. 8, 2015
(86) PCT No.: PCT/EP2015/078970

§ 371 Date: May 4, 2017

(30) Foreign Application Priority Data
Jan. 20, 2015 (DE) 10 2015 200 801.0

(51) Int. Cl. H04L 29/06; G06F 3/06; B60R 16/023; G06F 9/50; G06F 21/53; G06F 21/85; G06F 9/455

(52) U.S. Cl. CPC H04L 63/0218; G06F 21/53; G06F 3/0644; G06F 21/85; B60R 16/0231; G06F 9/5077; G06F 2009/45587; G06F 2009/45595

(57) ABSTRACT

An electronic control device comprising a number of application partitions and a firewall partition, also comprising a number of secure interfaces which can only be accessed by the firewall partition. This increases the safety of the electronic device for example when used as an embedded controller.

### CROSS REFERENCE TO RELATED APPLICATIONS

This application is the U.S. National Phase Application of PCT International Application No. PCT/EP2015/078970, filed Dec. 8, 2015, which claims priority to German Patent Application No. DE 10 2015 200 801.0, filed Jan. 20, 2015, the contents of such applications being incorporated by reference herein.

### FIELD OF THE INVENTION

The invention relates to an electronic control device, which can in particular be used as an “embedded controller” in motor vehicles.

### BACKGROUND OF THE INVENTION

Electronic control devices can be used in motor vehicles for a wide range of tasks. For example, they can be used to control driver assistance systems, convenience functions or safety facilities such as airbags.

In light of the increasing networking of vehicles with external facilities, such as within the scope of vehicle-to-X communication or automatic emergency call functions, the number of interfaces to different external systems that are integrated in vehicle electronics generally increases. Here, each interface to an external system generally entails a certain risk of attack, wherein for example an attacker can, via an interface, penetrate the vehicle electronics and thus also an electronic control device such as an embedded controller, and abuse said controller. Examples for such abuse can be the installation of different software, unauthorized remote control of vehicle functions, or unauthorized monitoring of the vehicle.

### SUMMARY OF THE INVENTION

For this reason, it is particularly important that electronic control devices in motor vehicles are secured against such attacks. An aspect of the invention is an electronic control device which features particularly reliable security.

An aspect of the invention relates to an electronic control device. Said device features a number of application partitions, wherein in each application partition a respective application is implemented. It further features at least one firewall partition, in which a firewall is implemented. Further, it features a number of secured interfaces which are designed to communicate with the external appliances to the control device and/or with on-board appliances. The secured interfaces are here triggerable solely from the firewall partition. Further, a number of virtual interfaces are provided which are designed respectively to communicate between the firewall partition and at least one application partition.

By means of the electronic control device according to an aspect of the invention, a particularly high level of security can be achieved, since the respective applications can only access the secured interfaces via the firewall by means of the virtual interfaces. Even in cases when an attacker may succeed, for example, in replacing an application without authorization, said attacker can still not access the secured interfaces using this malicious software. If for example the firewall detects data traffic that is untypical for the application that is actually expected in the respective partition, the firewall can block such data traffic. Thus, the control device can be protected against the environment, and also, the environment can be protected against the control device.

The firewall itself can preferably be protected against unauthorized replacement or alteration in that it is very simply programmed and thus features no weak points as possible targets of attack.

Within the scope of this application, a partition is understood in particular to be an area of a memory which is available to a certain application or also a firewall. The partitions are here typically designed in such a manner that already on the hardware side or also on the software side, it is ensured that an application can only implement reading and writing processes in a partition that has been assigned to it, and that no other application in this partition can implement reading and writing processes. Exceptions can for example occur with an overlap, which is described further below. Typically, the respective application or the firewall itself is also stored in a partition assigned to it.

The interfaces can for example be designed as hardware and enable communication with other appliances such as a CAN bus system, or also with on-board appliances. The secured interfaces are here triggerable according to the invention only from the firewall partition, which means in particular that data can only be issued and/or read from the firewall partition. Within the scope of this application, a virtual interface is regarded in particular as being an interpartition communication channel.

Preferably, the secured interfaces can be triggered from the firewall partition in such a manner that data can be issued from the firewall partition via the secured interfaces. It can also be triggerable in such a manner that data from the firewall partition can be received via the secured interfaces. In particular, it can be provided that it can be issued or received solely from the firewall partition.

Preferably, the virtual interfaces respectively enable a transfer of data from at least one application partition to the firewall partition and/or from the firewall partition to at least one application partition. Thus, the virtual interfaces can advantageously serve the data exchange between application partitions and firewall partitions.

The virtual interfaces can in particular be provided by the firewall partition. They can be designed for the exclusive communication between a firewall partition and one or more application partitions.

At least one of the virtual interfaces can be formed by an overlap between a firewall partition and at least one application partition. In such an overlap, typically, both at least one application and one firewall can write data and read off from said data. It should be understood that both a virtual interface and all virtual interfaces, or also any partial quantity required of the virtual interfaces available overall can be designed in such a manner.

According to one embodiment, at least one of the virtual interfaces is formed by means of a dedicated register, which does not belong to an application partition, or to a firewall partition, and which can be addressed from at least one application partition and from the firewall partition. Such a dedicated register is typically accessible both from the application partition and also from the firewall partition with regard to reading and writing access. This enables the data exchange in a similar manner to the overlap of partitions just described above. It should be understood that both a virtual interface and all virtual interfaces, or also any partial quantity required of the virtual interfaces available overall can be designed in such a manner.

According to a preferred embodiment, the firewall is designed to prevent a data flow between a virtual interface and a secured interface when the respective data flow is impermissible according to a specified list. This corresponds to a blacklist principle, in which data traffic is in general permitted, unless it is explicitly classified as being impermissible through specific rules which can be stored in the list, for example.

According to an alternative embodiment to this, which is also preferred, the firewall is designed to only permit a data flow between a virtual interface and a secured interface when the respective data flow is impermissible according to a specified list. This corresponds to the reversal of the blacklist principle, and is also known as the whitelist principle. Here, the data traffic is in general impermissible, unless it is explicitly permitted, for example via the list.

It should be understood that the specified lists, which can for example be a blacklist or a whitelist, can depend on the system state, for example normal operation, open diagnosis session, software update, or other possible states. Such system states can for example relate to the control device or to an entire vehicle, of which the control device is a part. It should further be understood that the blacklist principle and the whitelist principle, as described above, can also be combined with each other. For example, also depending on the system state, either the blacklist principle or the whitelist principle can be used.

Preferably, the firewall is designed to report a data flow between a virtual interface and a secured interface when the respective data flow is to be reported according to a specified list. Thus, the data flow can be monitored, for example by means of the fact that with certain potentially unusual data patterns, a report is sent to a monitoring unit or for example to the manufacturer or a fleet manager of a motor vehicle.

According to one embodiment, the electronic control facility features a number of non-secured interfaces which are designed to communicate with the external appliances to the control device or with on-board appliances. The non-secured interfaces are here directly triggerable from at least one application partition or via the firewall partition in such a manner that between the application partition and the non-secured interface, replaced data is in general permitted by the firewall. This makes it possible to prevent an inspection by the firewall for uncritical interfaces, which can for example save computing time. For example, such a principle can be used for non-critical General Purpose Input/Output (GPIO) pins.

The firewall partition can be a component of a plurality of firewall partitions, wherein each firewall partition is assigned to a number of secured interfaces. This permits the distribution of the monitoring task over several firewalls, wherein each firewall typically runs in its own partition.

It should be mentioned that a number of elements within the scope of this application refers either to such an element or several such elements.

The electronic control device can in particular be designed as an embedded controller. This permits its use in typical applications in motor vehicles, for example for the applications described in the introduction. Equally, it can be designed as a cyber physical device.

According to a preferred embodiment, the electronic control device features a memory management unit, or MMU. The memory management unit can manage the partition. A memory management unit can here implement an address virtualization in particular. This can mean that the application works with virtual addresses that are decoupled from physical addresses. Mapping between virtual and physical addresses is managed by the memory management unit. Addresses to which an application should have no access do not exist for this application at all.

Alternatively or in addition to the use of a memory management unit, a memory protection unit, or MPU, can be used. The memory management unit can also manage the partition. Here, all applications typically work with the physical addresses, wherein however a memory protection unit can prevent access to certain memory areas. Addresses to which an application should not have access do exist, but a writing/reading attempt merely generates an error.

According to a preferred embodiment, the electronic control device features an operating system. The operating system can prevent direct access to the secured interfaces from the application partitions. The operating system can also enable communication between different partitions, in particular by providing an overlap of the respective partition or by providing a dedicated register. The operating system can also assign computing time to different applications. Additionally, the operating system can configure a memory management unit or a memory protection unit.

The secured interfaces can in particular be one or more of the following interfaces:

General Purpose Input/Output, GPIO,
Serial Peripheral Interface, SPI,
Controller Area Network, CAN,
Ethernet,
Universal Asynchronous Receiver/Transmitter, UART,
FlexRay,
LIN,
Secure Digital Input/Output, SDIO,
I2C,
other, in particular serial, interfaces.

As examples, only a few typical rules are named, which can be implemented when several of the named interfaces are used.

When GPIO is used, a frequency can in particular be monitored with which individual pins may change their level. A comparison with an SPI module can also be made as to whether data traffic is indeed occurring when a Chip Select Pin is activated.

When SPI is used, a frequency can be monitored in which messages to certain bus participants (recognizable via Chip Select) can be sent or received. Permitted operations codes from SPI messages or valid lengths of SPI messages can be determined. A comparison with GPIO can also be made as to whether data exchange is occurring synchronously with Chip Select control.

When CAN/LIN/FlexRay or similar interfaces are used, a frequency can be monitored in which messages may be received or sent. Permitted IDs can be specified which may be sent or received. Permitted values can be checked within the messages. Further, the correct protocol use can be checked when a protocol is used.

When Ethernet/IP are used with UDP/TCP, a frequency can be checked in which messages may be received or sent. Non-permitted ports or non-permitted recipients or senders can be blocked. Deep Package Filtering can also be implemented to check the correct protocol use.

When UART is used, a frequency can be checked in which messages may be received or sent. The correct protocol use can also be checked.

### BRIEF DESCRIPTION OF THE DRAWINGS

Further features and advantages will be derived by persons skilled in the art from the exemplary embodiment described below with reference to the appended drawing.

FIG. 1 shows an electronic control device according to an aspect of the invention.

### DETAILED DESCRIPTION OF THE PREFERRED EMBODIMENTS

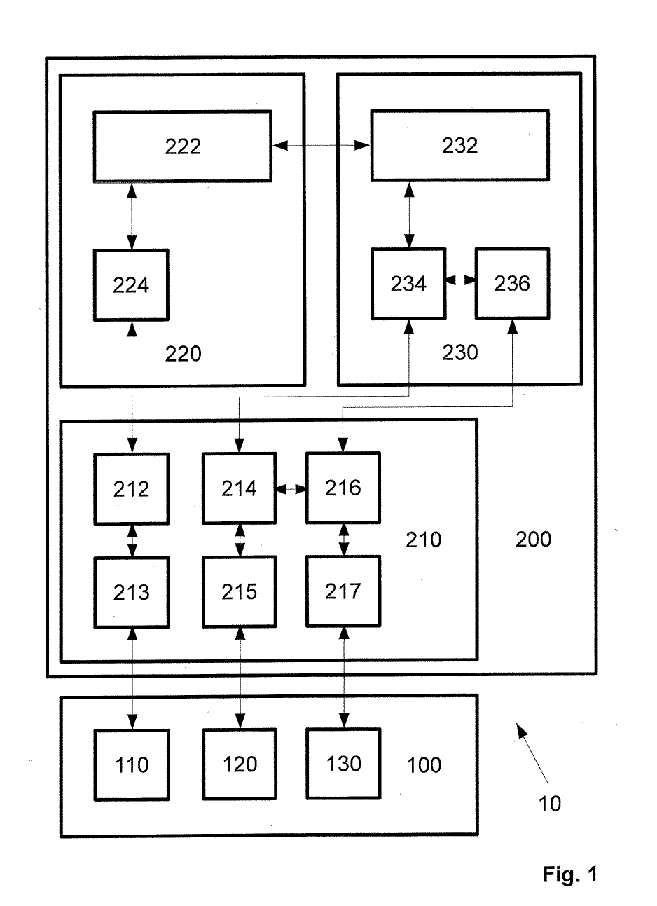

FIG. 1 shows an electronic control device in the form of a microcontroller 10. The microcontroller 10 features an interface part 100 and a partition part 200. In the interface part 100, as presented, a CAN interface 110, and SPI interface 120 and a GPIO interface 130 are implemented. In the partition part 200, a firewall partition 210, a first application partition 220 and a second application partition 230 are implemented. In the firewall partition 210, a firewall is executed. In the first application partition 220, a first application is executed. In the second application partition 230, a second application is executed.

The firewall running in the firewall partition 210 features a CAN driver 213, an SPI driver 215 and a GPIO driver 217. These drivers can communicate with the interfaces 110, 120, 130 of the interface part 100, and thus address these interfaces 110, 120, 130, so that communication is possible with external appliances or with on-board appliances. As can be seen in FIG. 1, the interfaces 110, 120, 130 can only be addressed by the drivers 213, 215, 217. This means in particular that they can only be addressed from the firewall partition 210. Direct access to the interfaces 110, 120, 130 from the two application partitions 220, 230 is not possible.

The firewall further features a CAN inspection module 212, an SPI inspection module 214 and a GPIO inspection module 216. The inspection modules 212, 214, 216 are designed to inspect the respective data traffic to the drivers 213, 215, 217. In particular, they are designed to monitor the respective data traffic as to whether suspicious or forbidden data is included. In this case, the data traffic would be immediately stopped. This corresponds to the so-called blacklist principle, in which communication is generally permitted, but is prevented when certain rules or criteria apply. Even in cases when for example an attacker might succeed in incorporating malware into one of the application partitions 220, 230, a potentially malicious communication to the outside could be prevented by the firewall. Here, too, reference is made to the fact that the interfaces 110, 120, 130 which ultimately create the connection to the outside can only be addressed from the firewall partition 210 and thus only data traffic reaches the outside or is received from the outside which has been inspected by one of the inspection modules 212, 214, 216. As is shown, it is also provided that the SPI inspection module 214 and the GPIO inspection module 216 can exchange data with each other.

As is shown, the first application partition 220 is designed in such a manner that the first application, which executes e.g. an algorithm 222, can access the CAN interface. For this purpose, a virtual CAN interface 224 is provided which is primarily designed as a register, which can be accessed both by the first application partition 220 and by the firewall partition 210. This enables the first application to exchange data with the firewall in the firewall partition 210 from its first application partition 220, which is then forwarded to the CAN interface 210, unless it contravenes any rules. A similar process occurs when data is received via the CAN interface 110.

The second application, which runs in the second application partition 230 and which executes e.g. an algorithm 232, can by contrast access the SPI interface 120 and the GPIO interface 130. For this purpose, a virtual SPI interface 234 and a virtual GPIO interface 236 are implemented which are primarily designed as a register, which can be accessed both from the second application partition 230 and from the firewall partition 210. This enables a data exchange in the same form between the second application partition 230 and the firewall partition 210, so that the second application can access the SPI interface 120 and the GPIO interface 130 from its second application partition, i.e. it can send data via these and receive data via these. The corresponding data traffic is monitored by the firewall in the firewall partition 210. Additionally, communication is also provided between the virtual SPI interface 234 and the virtual GPIO interface 236.

As presented, communication is also possible between the two applications in the application partitions 220, 230.

It should be mentioned that the firewall running in the firewall partition 210 is particularly simply programmed, so that it offers no weak points which could be exploited by attackers. It is thus considerably less likely that an attacker will succeed in compromising the firewall in the firewall partition 210 than one of the applications in the application partitions 220, 230. Even if the latter should occur, despite all precautionary measures, the firewall would still continue to function, which due to the mandatory required implemented by the hardware to permit data traffic to run via the firewall can capture any malicious data traffic.

The claims which are a part of the application do not represent a waiver of the attainment of further protection.

Insofar as it emerges during the course of the procedure that a feature or a group of features is not absolutely necessary, a formulation is already sought at this stage by the applicant of at least one independent claim, which no longer comprises the feature or group of features. This can for example be a sub-combination of a claim present on the day of application, or a sub-combination which is restricted by further features of a claim present on the day of application. Such claims or feature combinations to be newly formulated should be understood as being covered by the disclosure of this application.

Reference is further made to the fact that designs, features and variants of the invention which are described in the different embodiments or exemplary embodiments and/or shown in the figures can be combined with each other in any way desired. Individual or multiple features can be exchanged as required. Such claims or feature combinations thus created should be understood as being covered by the disclosure of this application.

References in dependent claims should not be understood as a waiver of the attainment of independent, concrete protection for the features of the subclaims to which reference is made. These features can also be combined with other features as desired.

Features which are only disclosed in the description, or features which are only disclosed in the description or in a claim in connection with other features can in general be of independent importance of essence to the invention. They can therefore also be claimed individually as a differentiation from the prior art.

It should be understood that an electronic control device can in general feature processor means and memory means, wherein in the memory means, a program code is stored during the execution of which the processor means behave in a defined manner.

1. An electronic control device comprising
a number of application partitions, wherein in each application partition, a respective application is implemented,
at least one firewall partition, in which a firewall is implemented,
a number of secured interfaces which are designed to communicate with external appliances to the control device and/or with on-board appliances,
wherein the secured interfaces can be triggered solely from the firewall partition and
a number of virtual interfaces, which are designed respectively to communicate between the firewall partition and at least one application partition.
wherein the control device is designed as an embedded controller.

2. The electronic control device according to claim 1,
wherein the secured interfaces can be triggered from the firewall partition in such a manner that data can be issued from the firewall partition via the secured interfaces, and/or in such a manner that data can be received from the firewall partition via the secured interfaces.

3. The electronic control device according to claim 1,
wherein the virtual interfaces respectively enable a transfer of data from at least one application partition to the firewall partition and/or from the firewall partition to at least one application partition.

4. The electronic control device according to claim 1,
wherein at least one of the virtual interfaces can be formed by an overlap between a firewall partition and at least one application partition.

5. The electronic control device according to claim 1,
wherein at least one of the virtual interfaces is formed by means of a dedicated register, which does not belong to an application partition, or to a firewall partition and which can be addressed from at least one application partition and from the firewall partition.

6. The electronic control device according to claim 1,
wherein the firewall is designed to report a data flow between a virtual interface and a secured interface when the respective data flow is impermissible according to a specified list.

7. The electronic control device according to claim 1,
wherein the firewall is designed to only permit a data flow between a virtual interface and a secured interface when the respective data flow is permissible according to a specified list.

8. The electronic control device according to claim 1,
wherein the firewall is designed to report a data flow between a virtual interface and a secured interface when the respective data flow is to be reported according to a specified list.

9. The electronic control device according to claim 1,
which further features a number of non-secured interfaces, which are designed to communicate with appliances external to the control device,
wherein the non-secured interfaces are directly triggerable from at least one application partition or via the firewall partition in such a manner that between the application partition and the non-secured interface, replaced data is in general permitted by the firewall.

10. The electronic control device according to claim 1,
wherein the firewall partition is a component of a plurality of firewall partitions,
wherein each firewall partition is assigned to a number of secured interfaces.

11. (canceled)

12. The electronic control device according to claim 1 further comprising:
a memory management unit,
wherein the memory management unit manages the partitions.

13. The electronic control device according to claim 1 further comprising:
a memory protection unit, MPU,
wherein the memory protection unit manages the partitions.

14. The electronic control device according to claim 1 further comprising:
an operating system,
wherein the operating system prevents direct access to the secured interfaces from the application partitions,
and/or
wherein the operating system enables communication between different partitions by providing an overlap of the respective partitions or by providing a dedicated register,
and/or
wherein the operating system assigns computing time to different applications, and/or
wherein the operating system configures a memory management unit or a memory protection unit.

15. The electronic control device according to claim 1,
wherein the secured interfaces can be one or more of the following interfaces:
General Purpose Input/Output,
Serial Peripheral Interface,
Controller Area Network,
Ethernet,
Universal Asynchronous Receiver Transmitter,
FlexRay,
LIN,
Secure Digital Input Output,
I2C,
other serial interface.
